(19) United States
(12) Patent Application Publication
(10) Pub. No.: US 2020/0048961 A1
(43) Pub. Date: Feb. 13, 2020

(54) NON-CONDUCTIVE ANODIZED GROUND AND AERIAL LADDERS FOR THE FIRE SERVICE

(71) Applicant: William Finegan, Philadelphia, PA (US)

(72) Inventor: William Finegan, Philadelphia, PA (US)

(21) Appl. No.: 16/538,053

(22) Filed: Aug. 12, 2019

Related U.S. Application Data
(60) Provisional application No. 62/717,085, filed on Aug. 10, 2018.

(51) Int. Cl. E06C 7/08; E06C 1/14; E06C 1/12; C23F 13/00; C09D 5/44

(52) U.S. Cl. CPC E06C 7/08; E06C 1/14; C09D 5/4484; C23F 13/005; E06C 1/12

(57) ABSTRACT

The non-conductive anodized aluminum ground ladder and the non-conductive anodized aluminum aerial ladder for the fire service uses non-conductive anodic oxide layer coatings in the manufacture of aluminum ground and aerial ladders to provide passive protection to all affected firefighters and civilians they may be rescuing in the event of inadvertent contact with high voltage power lines and/or other high voltage electrical conductors.

### BACKGROUND

Ground and aerial ladders are used in many situations in which access to heights is required. It is inherently dangerous to climb a ladder. This danger is compounded when conductive ladders are used in proximity to energized high voltage electrical conductors (powerlines), and the risk is compounded exponentially when ladders are used to rescue occupants of buildings that are on fire. The overwhelming majority of the ground and aerial ladders in the fire service are manufactured using aluminum, which conducts electricity, because fiberglass and other traditionally insulative materials may be damaged in high heat and are much heavier.

There have been multiple documented occasions when firefighters were forced to raise ground and aerial ladders in close proximity to high voltage lines and were electrocuted. Some were injured and others were killed in the line of duty.

The risk of electrocution in the workplace cannot be understated. NIOSH's Fatality Assessment and Control Evaluation Program reports more than 4,000 non-disabling electrical injuries and more than 3,600 disabling electrical contact injuries with more than 2,000 workers sent to burn centers for treatment every year. Electrocutions are the fourth leading cause of traumatic occupational fatalities. 90% of all accidental contacts with high-voltage power came from distribution lines.

The fire service firefighter must often operate in environments where the goals of OSHA/NIOSH (29 CFR 1926.1408(a)(2)(ii), which prohibits workers from coming within 20 feet of high voltage power lines. OSHA further specifically prohibits the use of lightweight aluminum ladders “where they may contact electrical conductors” (29 CFR 1926.1053(b)(2)). Unfortunately, because of the inherently dangerous and unpredictable nature of their work, firefighters are not covered by OHSA requirements.

The unique needs of the fire service are reflected in the design and construction requirements of the fire service ground ladders as found in the NFPA 1931 Standard for Manufacturer's Design of Fire Department Ground Ladders. This standard includes heat sensors on the inside of the beams, design specifications on width of ladders depending on the specific application, and greater load tests. As a result of these specific and rigorous standards, the only ladders that meet the technical requirements for use in the fire service for lengths greater than 35 feet are constructed using lightweight aluminum. The unique needs of the fire service combined with the NFPA 1931 requirements precludes the use fiberglass ladders of greater than 35 feet. Firefighters have been at continuous risk of death and injury from electrocution using lightweight aluminum ladders for more than 80 years.

The overwhelming majority of worker electrocutions for aluminum ladders touching or arcing with high voltage wires occurs with ladders that are 35′ or greater coming in contact with high voltage distribution wires (7,000-14,000 volts). This is a significant problem for the fire service because the 6.3 million miles of distribution lines account for 90% of all high voltage lines, and these high-voltage lines are located closest to the ground often in close proximity to where firefighters often need to work. The average height of a utility pole is 40 feet carrying the high-voltage distribution lines, which places firefighters working on ladders between 35 and 50 feet in height well within the danger zone of these high-voltage lines.

Typical resistive and/or insulative coatings to achieve non-conductive attributes including polyurethanes, epoxies, ceramics, and polymers may be non-feasible in fire service applications because they all add significant weight to the ladder.

### SUMMARY OF THE EMBODIMENTS

Voltage doesn't kill. Amperage kills. A non-conductive anodic oxide layer coating added to the surface of aluminum increases resistance in the circuit, then (Ohms law E=I×R), the amperage (current) will decrease. Coating an aluminum ladder with a non-conductive anodic oxide layer coating is a new and novel solution to a problem that has plagued the fire service for more than 50 years.

The lesson learned is that to prevent future loss of life from firefighters being electrocuted from ground ladders coming in contact with high-voltage lines, we do not need to reduce the current to zero. Any significant reduction in current will turn fatalities into injuries, and injuries will become “incidents.”

The non-conductive anodized aluminum ground ladder and the non-conductive anodized aluminum aerial ladder for the fire service may use non-conductive anodic oxide layer coatings in the manufacture of aluminum ground and aerial ladders to provide passive protection to all affected firefighters and civilians they may be rescuing in the event of inadvertent contact with high voltage power lines and/or other high voltage electrical conductors.

### BRIEF DESCRIPTION OF THE DRAWINGS

There are no figures.

### DETAILED DESCRIPTION OF THE EMBODIMENTS

The components of the anodized aluminum ground and aerial firefighting ladder include: an aluminum ladder having a non-conductive anodic oxide layer coating the surface of the aluminum rails and/or rungs. By anodizing the beams, the current flowing through the ladder to a person will decrease (to zero if fully insulating or to a safe low if resistive) with a corresponding decrease in the likelihood of current flowing through the heart and brain.

The non-conductive aluminum ground and aerial ladder may improve safety by providing protection against accidental electrocution by adding a non-conductive anodic oxide layer to the surface of the ladder. Creating non-conductive anodized aluminum can be accomplished using electrochemical treatments including electrochemical brightening, electropolishing, anodizing the metal, clear, color, integral color anodizing, electrolytically colored anodizing, dyed anodizing, combination color anodizing, interference color anodizing, bright anodizing, protective anodizing, decorative anodizing, architectural anodizing, hard anodizing, sealing, cold impregnation and/or significant surface coatings. Creating non-conductive aluminum using chemical treatments may include chemical brightening, chemical polishing, with surface preparations including degreasing, etching, pickling.

Coatings (organic) may include a coating material is applied on a metallic substrate. This process includes cleaning and chemical pre-treatment and either: one-side or two-side, single or multiple application of liquid or powder coating materials that are subsequently cured or laminating with plastic films. Creating non-conductive aluminum using other coating techniques may include coil coating, backing coat, chemical conversion coating and coating with paints including priming, pretreatment priming, single or multiple coat systems, organic coating, film coating, and/or lacquering. Thermal treatments including solution heat treatments, quenching, precipitation hardening, and age hardening may also be applied in the process.

The base metal aluminum may be free from surface defects, caused by machining, cutting, scratching, polishing, buffing, roughening, bending, stretching, deforming, rolling, sandblasting, vapor blasting, etching, heat treatment condition, alloy chemistry imbalance and inclusions, that will cause coated test panels or parts to fall any of the requirements of this specification.

The base metal may be subjected to cleaning, etching, anodizing and sealing procedures as necessary to yield coatings meeting all requirements of MIL-A-8625F.

The anodic layer (Type III) coatings may be the result of treating aluminum and aluminum alloys electrolytically to produce a uniform anodic coating on the metal surface.

Type III coatings may be prepared by any process operation to produce a heavy dense coating of specified thickness, weight, and abrasion resistance on aluminum alloys.

Coatings may be sealed to obtain the maximum degree of abrasion and wear resistance per the requirements of MIL-A-8625F.

Type III coatings may not be applied to aluminum alloys with a nominal copper content in excess of 5 percent or a nominal silicon content In excess of 8.0 percent.

Alloys with a nominal silicon content higher than 8.0 percent may be anodized subject to approval of the procuring activity.

Heat treatable alloys may be in a temper obtained by heat treatment, such as -T4, -T6, or T73, prior to anodizing.

Coating electrolytes may be aqueous solutions containing oxalic acid, boric acid plus ammonium borate and nitrides.

There coating process may use coating electrolytes, other than sulfuric acid, for coatings including aqueous solutions containing both sulfuric and oxalic acids for the bath. Other baths used less frequently and for special purposes employ sulfosalicylic, sulfamic or sulfophthalic acid solutions.

The coatings may be of separate classes:

Class 1. The anodic coating may not be dyed or pigmented. Any natural coloration resulting from anodic treatment with the various alloy compositions may not be considered coloration. The characteristic color imparted by the sealing process may also be considered as non-dyed.

Class 2. The anodic coating may be uniformly dyed or pigmented by exposure to a solution of a suitable type dye or stain. The color on wrought alloys may be uniform. Cast alloys may exhibit dye bleed-out or lack of color (or color uniformity) associated with the Inherent porosity of the casting. The dyes and pigments used may not be damaging to the anodic coatings.

While the invention has been described with reference to the embodiments above, a person of ordinary skill in the art would understand that various changes or modifications may be made thereto without departing from the scope of the claims.

1. A firefighting ladder comprising:
a ladder that meets the NFPA 1931 Standard for Manufacturer's Design of Fire Department Ground Ladders;
a coating on portions of the ladder, wherein the coating is non-conductive.

2. The firefighting ladder of claim 1, wherein the ladder comprises rails and rungs.

3. The firefighting ladder of claim 2, wherein the coating is a non-conductive anodic oxide layer that covers the rails and rungs.

4. The firefighting ladder of claim 3, wherein the non-conductive anodic oxide layer is selected from a group consisting of electrochemical treatments including electrochemical brightening, electropolishing, anodizing the metal, clear, color, integral color anodizing, electrolytically colored anodizing, dyed anodizing, combination color anodizing, interference color anodizing, bright anodizing, protective anodizing, decorative anodizing, architectural anodizing, hard anodizing, sealing, and cold impregnation.

5. The firefighting ladder of claim 1, wherein the coating comprises a chemical treatment.

6. The firefighting ladder of claim 5, wherein the chemical treatment is selected from a group consisting of chemical treatments may include chemical brightening, chemical polishing, with surface preparations including degreasing, etching, and pickling.

7. The firefighting ladder of claim 1, wherein the coatings include application of a powder coating.

8. The firefighting ladder of claim 7, wherein the powder coating is cured.

9. The firefighting ladder of claim 7, wherein the powder coating is laminated with a plastic film.

10. The firefighting ladder of claim 1, wherein the coating is selected from a group consisting of: coil coating, backing coat, chemical conversion coating and coating with paints including priming, pretreatment priming, single or multiple coat systems, organic coating, film coating, and lacquering.

11. The firefighting ladder of claim 1, wherein the coating includes a thermal treatment.

12. The firefighting ladder of claim 11, wherein the thermal treatment is selected from a group consisting of: solution heat treatments, quenching, precipitation hardening, and age hardening.

13. The firefighting ladder of claim 1, wherein the ladder is a ground ladder.

14. The firefighting ladder of claim 1, wherein the ladder is an aerial ladder.
